(19) United States
(12) Patent Application Publication
(10) Pub. No.: US 2016/0183553 A1
(43) Pub. Date: Jun. 30, 2016

(54) MERINGUE COMPOSITION AND METHODS OF PREPARATION

(71) Applicants: Kent Kirshenbaum, New York, NY (US); Alizee Guegan, Pluherlin (FR)

(72) Inventors: Kent Kirshenbaum, New York, NY (US); Alizee Guegan, Pluherlin (FR)

(73) Assignee: New York University, New York, NY (US)

(21) Appl. No.: 14/237,319

(22) PCT Filed: Aug. 3, 2012
(86) PCT No.: PCT/US2012/049526

§ 371 Date: Oct. 3, 2015

Related U.S. Application Data
(60) Provisional application No. 61/515,633, filed on Aug. 5, 2011.

(51) Int. Cl. A23G 3/48; A23G 3/34; A23G 3/52; A23G 3/42

(52) U.S. Cl. CPC A23G 3/48; A23G 3/42; A23G 3/0004; A23G 3/52; A23V 2002/00

(57) ABSTRACT

A meringue composition is disclosed, which may be prepared without the inclusion of egg or egg byproduct material as an ingredient. The meringue is prepared from a mixture consisting essentially of saponin, a sugar or sugar substitute, and water. The meringue is capable of being prepared to a self-sustaining, baked product. The final meringue product may be prepared by a variety of heating methods, including microwave heating. Further, the nature of the final product may be controlled by the extent of heating, so that a product more flowable or creamy may be achieved by a reduction in the heating time. The meringue of the invention is suitable for strict vegetarians (‘vegans’) and individuals who are allergic to eggs and egg bi-products.

### BACKGROUND OF THE INVENTION

1. Field of the Invention

The invention relates to the field of confectionery products, and particularly, relates to the preparation of a confectionery meringue which contains no animal matter, and which can be prepared as a baked product, and alternatively, which can be prepared in a dry form for use as an ingredient in a variety of food products where a meringue component is called for and desirable.

2. Description of the Related Art

As is known, both in home-made and in industrially manufactured procedures, meringue is a baking product essentially made of egg-whites and sugar whipped to a light but solid texture, that is first modeled into the desired shape, for example, by placing it into specific molds or by extruding it into controlled shapes, and is then oven baked until it solidifies, taking on a whitish color with varying golden brown hues or even other hues as a result of the addition of other ingredients.

Besides its use as a finished confectionery product, meringue is an important semi-finished product of the confectionary industry and is used as a component or decoration for more complex confectionary products, or for ice-creams, ice-cream cakes and the like. Granulated or powdered to more or less fine dimensions after baking, it is a widely used component for coatings and decorations such as in ice-cream products.

Confectionery manufacturers have a need to offer a range of different products in order to satisfy different consumers or the differing needs of consumers on different occasions.

In some circumstances, variety can be provided by offering different textures, even within a range of otherwise similar products. For example, manufacturers have offered ‘ice-cream’ versions of popular confectionery pieces. Sometimes manufacturers offer a larger dimensioned (‘chunky’) version of a familiar product.

In general, an important consumer need is the desire for a ‘lighter’ textured product, which is not as filling as a familiar confectionery item, but which may retain the well-liked flavor profile of the original confectionery item. The use of meringue as a component in such confections has favorably responded to this need.

The meringue products that are currently offered and are commercially available, are generally made from egg whites and sugar, to which are usually added thickeners such as starch, and flavorings such as vanilla or the like, in small quantities. The egg whites may be separated from fresh eggs, or may be supplied from dry or powdered eggs, to which is added a quantity of water that is equivalent to that found in fresh egg whites. The sugar component may be granulated sugar and/or superfine sugar. An exemplary meringue composition may be as follows:

| Typical ingredients | Indicative % |
|---|---|
| water | 12.62 |
| egg-white | 1.26 |
| superfine sugar | 63.12 |
| granulated sugar | 16.41 |
| wheat starch | 6.56 |
| vanilla flavoring | 0.006 |

A growing segment of the consuming population, known as ‘vegans’, observes a dietary regimen that adheres strictly to the exclusive consumption of vegetables, and the corresponding exclusion from their diet of all animal matter, be it dairy or meat. While meringue is a popular confection, baked product and baking additive, the inclusion of egg whites in its preparation has prevented its consumption by this population. Another segment of the population includes the people who have allergies to eggs and egg by-products. This segment of the public has been unable to consume traditional meringue products, and has instead been forced to forego such foods.

Also, there exist confectionery preparations, that purport to offer a purely vegetable-based alternative, and one such preparation that is primarily Middle Eastern in origin, is known as Natef (or Natif). This material is prepared from saponin-containing plants, and has been prepared and used as a dessert topping, usually with a syrup additive, but has never been taught to be capable of independent preparation as a baked product such as the confections that may be prepared from the egg white-containing meringue preparations.

Accordingly, it is an object of the invention to provide a meringue formulation and preparation that yields a desirable meringue product that can be successfully prepared by baking, and that will possess the physical and organoleptic properties that are desirable, while providing a meringue product for consumption by strict vegetarians and others who cannot ingest eggs or egg byproducts, due to allergies or the like.

### SUMMARY OF THE INVENTION

According to one aspect of the invention, there is provided a meringue product formed from a mixture comprising a plant-derived foaming agent, preferably saponin, from which is prepared a saponin-rich component; sugar or a sugar substitute; and water. The meringue may be prepared individually as a baked product, or may be prepared in dry, granular form for use as a baking ingredient.

As used herein, the term ‘meringue’ is intended to cover a baked product that offers a light, ‘brittle’ or ‘crunchy’ texture, and that may be prepared from a mixture comprising saponin, which may be derived from one or more of saponin-containing plants; sugar or a sugar substitute; and water. The product may be initially formed in a substantially aqueous state and then prepared as a free-standing product and baked to completion. Alternatively, the ‘meringue’ may be prepared to a granular or powdered state and used in that manner as an ingredient in other food products or confections, or as a packing material.

The major advantage of the inventive meringue is that it contains no egg product or byproduct, such as egg white, and yet exhibits the physical, rheological and organoleptic properties of meringues prepared with egg white. Thus, the meringue of the invention may be prepared as a free-standing confection, or may be prepared as indicated herein, as a dried ingredient for inclusion in various food preparations where such an ingredient is desired or added. In the case of the free standing preparation, the present meringue may be baked in the same manner as its egg white counterpart, and will yield a visually pleasing preparation exhibiting desirable texture, consistency and taste.

A further aspect of the invention relates to the method for the preparation of the meringue of the invention. Particular aspects include the soaking of the saponin-containing plant material in water to recover a saponin-rich component as a solution or supernatant, followed by the removal of a quantity of the water content to form a composition having desirable rheological characteristics, body and consistency to facilitate its molding and baking to a final food product. The water content may be reduced in volume by the following, non-limiting amounts; e.g. on the order of about 50%, from about 50% to about 70%, and particularly from about 50% to about 60%, of the water content. Following reduction in liquid content and filtration, the resultant preparation is mixed, for example, by agitation with a mixing device, until a foamy mass is obtained. The sugar or sugar substitute is then added to the mass, for example, in an amount that may be within the non-limiting range of from about 85% to about 120% of the mass, and the resultant mixture is further agitated. Thereafter the mixture may be heated at a temperature that may range from about 150° F. to about 300° F., after which the preparation may be cooled before removing to stand or serve. A further particular temperature range may be from about 150° F. to about 200° F.

In an alternative embodiment of the invention, the saponin-containing plant material may be soaked in water to recover the saponin, after which the resultant supernatant may be lyophilized to recover a dry powder containing the saponin material, to thereby prepare the saponin-rich component. This powder may be stored and used as an ingredient in preparations where it is desired to include a meringue component therein, and as an edible packing material.

More particularly, the source of the saponin material may vary, as numerous plants are known that contain saponin, and that may be used in accordance with the invention. Thus, saponins may be derived from plants such as Yucca schidigera and Quillaja saponaria, as well as from the plant Saponaria officinalis (soapwort). All such saponin-containing plants are contemplated herein, and are considered within the scope of the invention.

The sugar component of the meringue may be selected from monosaccharides such as glucose, fructose and galactose, and dissacharides such as sucrose, maltose and lactose. The monosaccharides, or simple sugars, are found fruits and plant juices, certain root vegetables, sugar cane and honey. Of these, galactose is found together with glucose, in the dissacharide, lactose. In turn, the dissacharides sucrose, maltose and lactose, are found in vegetables, grain and in milk, respectively. Certain of the sugars are further processed (refined) to form table sugar, and further, may be granulated, milled to a fine powder or simply screened. Sugars may be prepared as liquids, with for example, granulated sugar dissolved in water, and invert sugars are prepared in a like manner and form. The latter forms are conventional ingredients in prepared foods, including ice creams and other desserts.

In addition, the meringue product of the invention may be prepared in a sugar-free formulation, where sugar substitutes such as dextrose, sorbitol, xylitol, maltitol, and the synthetic sweeteners such as saccharin, stevioside, aspartame, sucralose, cyclodextrin, and the like, are added in place of sugar. The exact formulations and percentages of such ingredients may be determined within the skill of the art.

The meringue mixture may also include ingredients such as bulking or bodying agents, including starches such as wheat starch, corn starch, rice starch, tapioca starch, and the like, and stabilizers such as methyl cellulose, carboxymethyl cellulose, gum tragacanth, guar gum, xanthan gum, and the like; all of the forgoing ingredients being listed herein by way of non-limiting example only.

The final meringue product may be prepared by a variety of heating methods, including microwave heating. Further, the nature of the final product may be controlled by the extent of heating, so that a product more flowable or creamy, like a marshmallow consistency, may be achieved by an adjustment or reduction in the heating time, or overall regime.

Advantageously, the mixture may further include a variety of food flavorings, such as coffee, mocha, vanilla, various fruit flavors, nut flavors, and cocoa powder, by way of non-limiting example. The same and like flavor ingredients are available for incorporation into the meringue mixture, and/or may be prepared and used as toppings, and may be applied to the prepared meringue product as a coating. Any of the flavorings may be used in powder form or may be prepared in liquid form and may be applied as by sprinkling, dusting, dipping spraying, pouring, and the like. All such methods are within the skill of the art and are intended to be included herein.

Other objects and advantages will be apparent to those skilled in the art from a consideration of the ensuing detailed description that proceeds with reference to the following illustrative drawings.

### BRIEF DESCRIPTION OF THE DRAWINGS

FIG. 1 is a graph presenting the results of HPLC analysis at 214 nm of components recovered from a supernatant representing an extraction of powdered soapwort boiled in 1 liter of water for about 1 hour. The gradient was 5-95% ACN-H₂O in 10 min.

FIG. 2 is a graph presenting the results of HPLC analysis at 275 nm of components recovered from a supernatant representing an extraction of powdered soapwort boiled in 1 liter of water for about 1 hour. The gradient was 5-95% ACN-H₂O in 10 min.

FIGS. 3A-3C are photographs depicting the visual and physical differences between foams and powders prepared by water extraction and extraction in ethanol.

FIG. 4 is a graph presenting the results of the measurement of the solids generated from lyophilized samples obtained at different boiling times, where the initial solution was prepared with 20 g of soapwort soaked in 2 L of boiling water.

FIG. 5 is a graph presenting the results of the measurement of the solids generated from lyophilized samples obtained at different boiling times, where the initial solution was prepared with 10 g of soapwort soaked in 1 L of boiling water.

FIG. 6 is a graph presenting the results of a comparison of stability in terms of half-life as a function of the amount of sugar present in samples. The maximum stability was found to be in the range of 85-115% sugar content.

FIG. 7 is a graph presenting the results of a comparison of foam height as a function of the pH of each of the samples. The pH was varied by the addition of lemon juice in different amounts to the respective samples, so that samples were prepared where the pH was 5, 3 and 2, respectively.

FIG. 8 is a graph presenting the results of a further measurement of foam height and stability as a function of the pH of the samples. The greatest longevity of foam stability was observed for a sample with a pH of 5.

FIGS. 9A-9C are photographs depicting the visual and physical differences between meringue foams baked at different temperatures. FIG. 9A shows the foam heated at 200° F., FIG. 9B shows the foam heated at 300° F., and FIG. 9C shows the foam heated at 400° F.

### DETAILED DESCRIPTION OF THE PREFERRED EMBODIMENTS

The invention provides a formulation for a meringue product which is suitable for consumption by strict vegetarians (‘vegans’) as well as individuals who cannot ingest egg products or egg-containing byproducts, and that yields the physical and organoleptic properties found in conventional meringue preparations. Both completed baked products, including confections, and powdered preparations useful as baking ingredients, are contemplated and may be prepared in accordance herewith and as described herein.

The following describes exemplary and non-limiting procedures whereby a meringue in accordance with the invention can be prepared. It is to be understood that the following procedures and specific ingredients may vary within the scope of the invention. Likewise, and as stated throughout, the meringue of the invention may be prepared both as a completed product, and in a dry powdered ingredient form.

### Extraction and Identification of Saponins

Roots of Saponaria officinalis contain triterpenoid saponins: these may include saponariosides A, B, C, D, E, F, G, H, I, J, K, L, M; flavonoids: saponarin, vitexin, acetylvitexin, saponaretin; and quillaic acid [23].

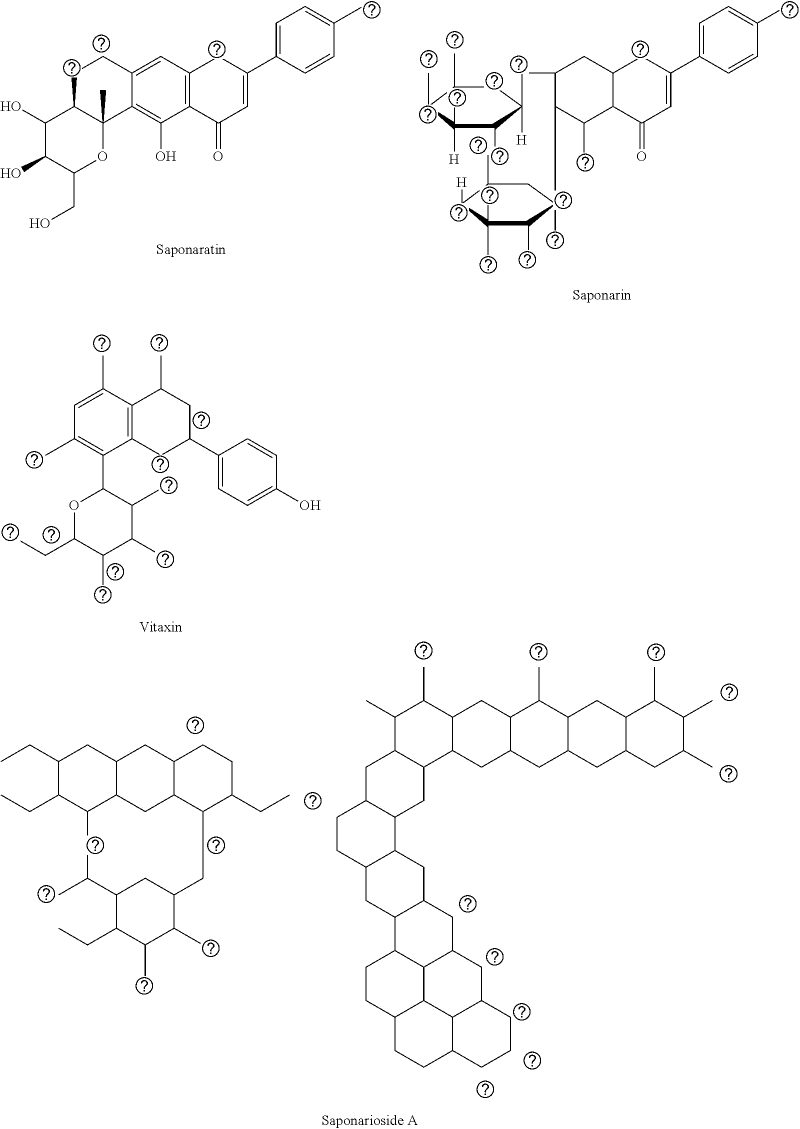

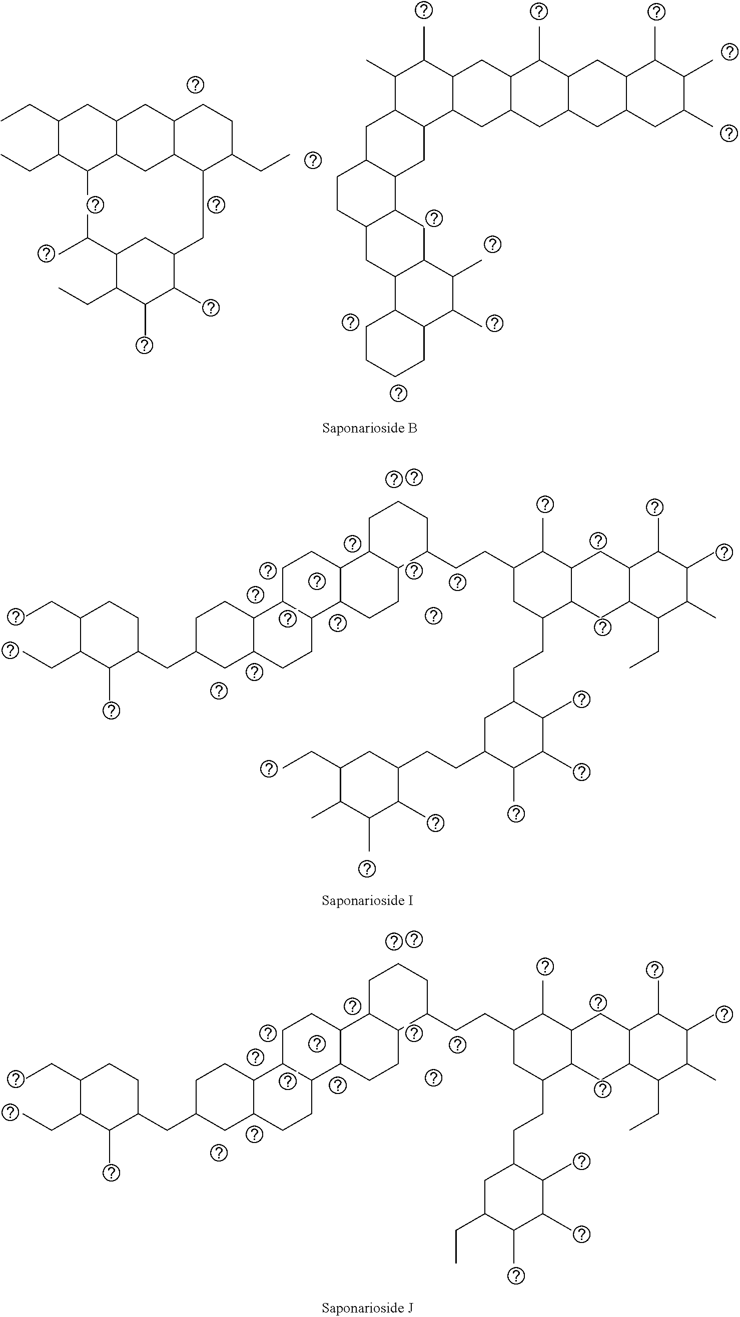

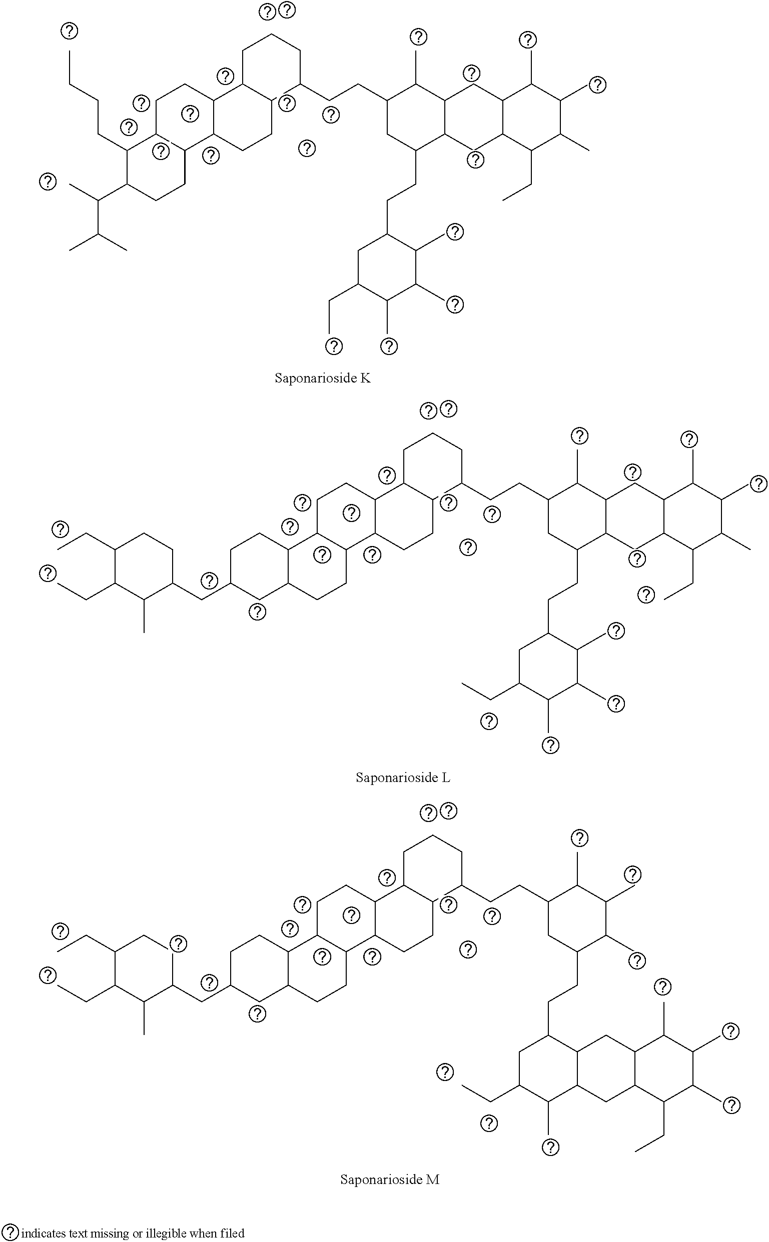

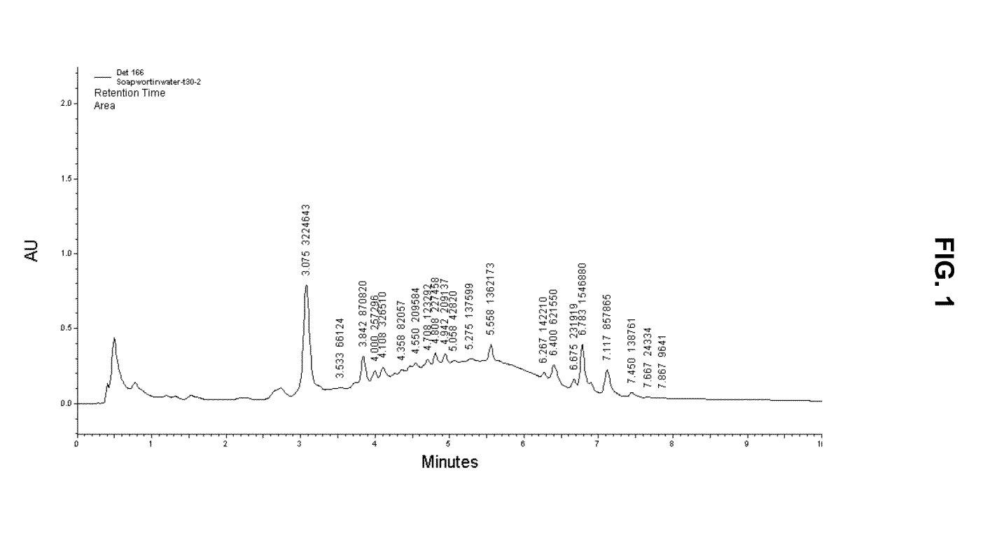

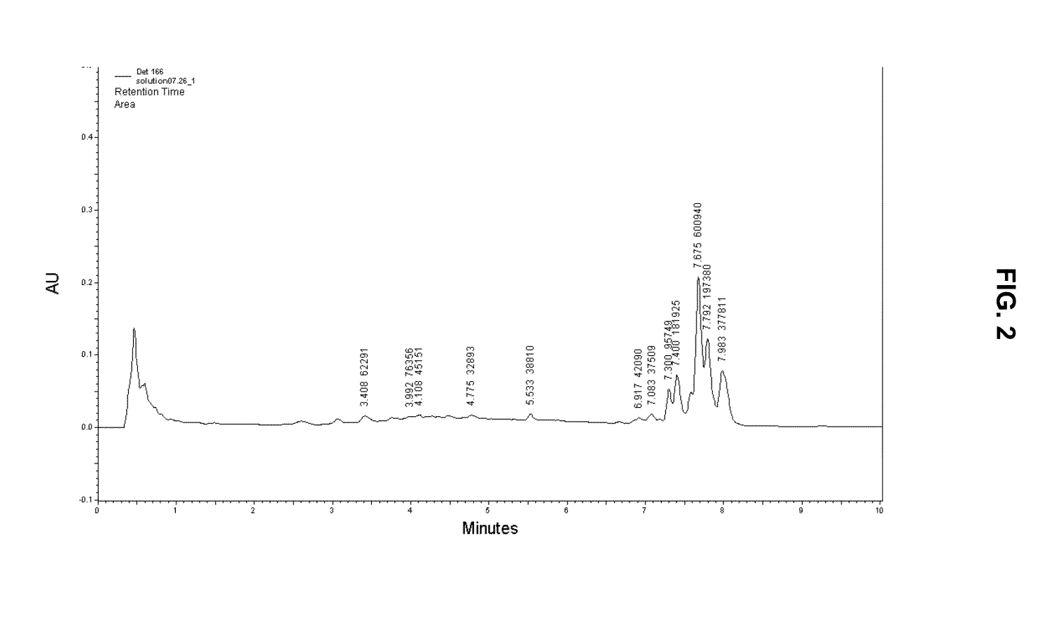

Initially, 10 grams of powdered soapwort roots were soaked in 1 liter of water for 1 hour. The resulting supernatant was then boiled for approximately 30 minutes to reduce the total liquid volume to from one-half to one-third, and was thereafter filtered. The filtrate was centrifuged, and the collected supernatant was then analyzed by HPLC at 214 nm and 275 nm. The results are presented in FIGS. 1 and 2, respectively.

Referring to the figures and particularly to FIG. 2, many more components were detected at 275 nm, which made the utilization of the spectrum difficult. The solution was found to contain components such as lipids or tannins which are evident from the brownish color of the solution.

### Characterization

To obtain foam with the requisite characteristics of foam formation and stability, 10 grams of powdered soapwort root were placed in 1 liter of water and soaked therein for 1 hour. In an alternate procedure, 100 grams of soapwort roots were soaked overnight in a comparable volume of water. Using powder soaked for one hour instead of whole roots soaked overnight was found to shorten the extraction time, while yielding the same volume of foam possessing the same stability.

The resulting preparation was then boiled for approximately 30 minutes to reduce the volume of the liquid component prior to filtration, by about one half to one third. After filtration, the filtrate was centrifuged, and the supernatant was collected and finally lyophilized. After lyophilization, a mean mass of 0.1905±0.0001 g of solid was recovered from 15±1 mL of liquid, so that the anticipated concentration is 12.70±0.07 g/L of solid.

According to a previous study, Saponaria officinalis extract contains 11.58-19.58% saponins [26] and the concentration of saponins in solution is accordingly about 1.47-2.49±0.07 g/L. 100±1 mL of water rich in saponins makes 1.0±0.2 L of foam. We find that 1.0±0.2 L of foam can produce around 200 small baked meringues. The average volume of a meringue is thus approximately 5±2.5 mL, so that a meringue contains about 7-12±5-7 mg saponins

### Effect of Solvent

Traditional recipes for Natef include extracting saponins with water, whereas scientific research indicates a protocol of extraction of saponins using alcohol (methanol or ethanol) [27].

A first extraction was made using water. Accordingly, 0.10 gram of soapwort powder was placed in 10.0±0.1 mL of water and soaked for a period of 1 hour (ratio 1:100). The entire solution was then boiled until approximately one half of the liquid remained, and the remaining solution was then passed through No. 1 filter paper. The filtrate was then centrifuged for 5 min at 3000 G, after which the supernatant was collected and lyophilized. A second extraction was then made, following the same procedure but using 70% ethanol instead of water. The following demonstrates the difference in the extent of the recovery of saponins as a function of the extraction solvent.
Water extraction: m_{extract, H2O}=34.0±0.4 mg
Ethanol extraction: m_{extract, EtOH}=20.0±0.3 mg

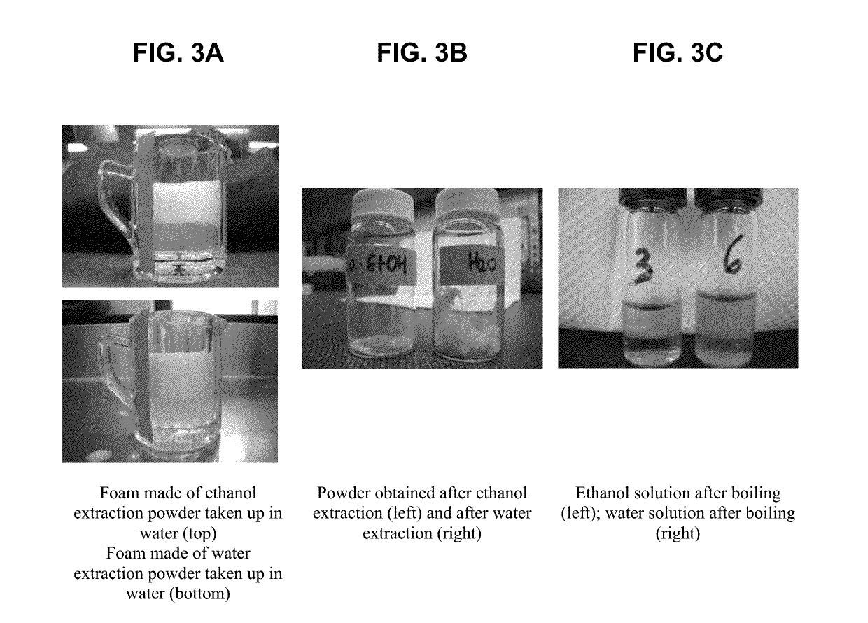

Accordingly, separate samples each containing 16.2±0.9 mg of each powder, were placed in 50±1 mL water, and were beaten using an electric beater (Max Watts 300 KitchenAid, St. Joseph, Mich. USA) at setting 10, for a period of 5 minutes. The total contents of each sample was then transferred to separate respective 140 mL clear jars (55 mm diameter), and the following measurements were taken. FIGS. 3A-3C are pictures of the materials processed with the respective solvents.
Mean half-life after Water extraction: 13 min;
   Ethanol extraction: 6 min.

### Discussion

Although many of the studies use alcohol to extract saponins, the better solvent for the purposes of the present invention appears to be water, because of the greater stability of the foam prepared from water extracted powder. In addition, it has been observed that the ethanol solution after extraction is much less colored than the water solution. This appears to indicate that ethanol may extract fewer of the other components in the powdered extract, which in turn, may impede the complete and thorough analysis of the saponins, and thereby avoid additional treatments.

### Effect of Concentration

Concentration of the saponin-containing solution increases as a function of the time that the soapwort is boiled in water. Accordingly, 20 g of powdered soapwort were soaked during one hour in 2 L water (ratio 1:100). The total mixture was then boiled successively for 10, 15, 20, 25, 30 and 40 minutes, respectively, and 50 g samples were collected after each boiling time. Each sample was filtered through a coffee filter (No. 4), and was then beaten for 5 minutes using an electric beater (Max Watts 300 KitchenAid, St. Joseph, Mich. USA) at setting 10. The remaining liquid and the foam were transferred into a 104 mL clear jar (55 mm diameter) for measurement.

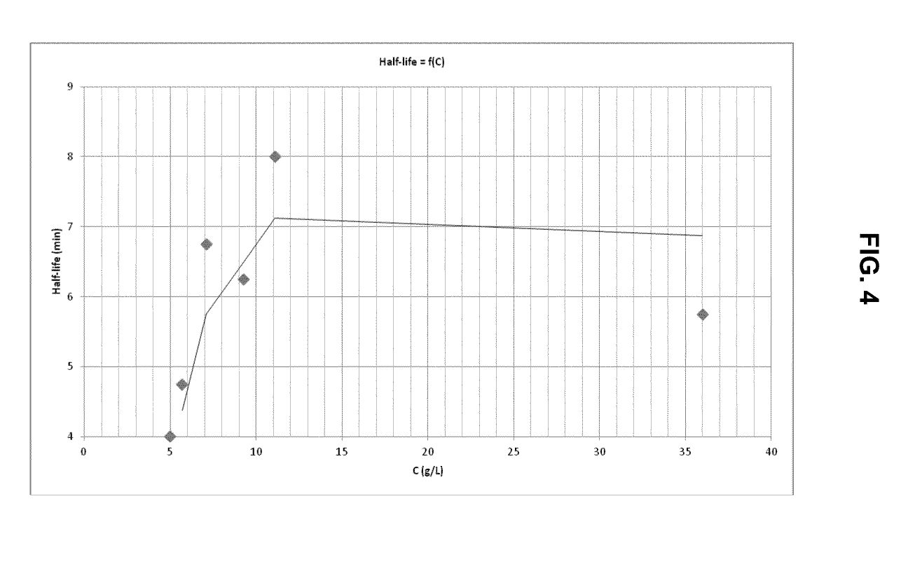

Samples of 10 mL of each filtrate were lyophilized to determine the solids concentration obtained at the different boiling times. The results are presented in Table 1, below, and in FIG. 4 and the summary tabulation from that figure, following after Table 1.

TABLE 1

| Boiling time (min) | 10 | 15 | 20 | 25 | 30 | 40 |
|---|---|---|---|---|---|---|
| Remaining volume | 1500 | 1400 | 1200 | 1000 | 800 | 400 |
| (mL) | | | | | | |
| Remainder (%) | 75 | 70 | 60 | 50 | 40 | 20 |
| Concentration in | 5.0 ± 0.3 | 5.7 ± 0.3 | 7.1 ± 0.4 | 9.3 ± 0.5 | 11.1 ± 0.6 | 36 ± 2 |
| solid (g/L) | | | | | | |
| Concentration range | 0.6 ± 0.3 | 0.7 ± 0.3 | 0.8 ± 0.4 | 1.1 ± 0.5 | 1.3 ± 0.6 | 4 ± 2 |
| in saponins (g/L) | 1.0 ± 0.3 | 1.1 ± 0.3 | 1.4 ± 0.4 | 1.8 ± 0.5 | 2.2 ± 0.6 | 7 ± 2 |
| Half-life (min) | 4 | 4.8 | 6.8 | 6.3 | 8 | 5.8 |

| | |
|---|---|
| Initial volume | 2000 mL |
| Maximum stability for | 11.1 ± 0.6 g/L |
| Equivalent concentration in | 1.3 ± 0.6 |
| saponins (g/L) | 2.2 ± 0.6 |
| Equivalent volume | 800 mL |
| Remainder amount expected | 40% |

The same experiment was done with 10 g of powdered soapwort that was soaked for 1 hour in 1 L water (ratio 1:100). The entire mixture was boiled for 10, 15, 20, 25, 30 and 40 minutes, respectively, and 50 g samples were collected at the end of each boiling time interval. Each sample was filtered through a coffee filter (No. 4), and was beaten for 5 minutes using an electric beater (Max Watts 300 KitchenAid, St. Joseph, Mich. USA) at setting 10. The remaining liquid and the foam were transferred into a 104 mL clear jar (55 mm diameter) for measurement.

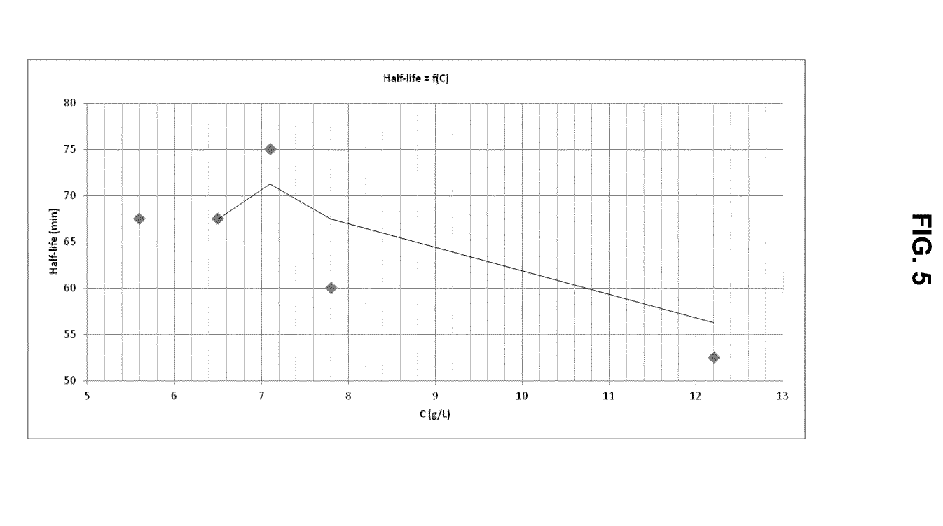

Samples of 10 mL of each filtrate were lyophilized to determine the total solids content at the different boiling times. The results are presented in Table 2, below, and in FIG. 5 and the summary tabulation from that figure, following after Table 2.

TABLE 2

| Boiling time (min) | 10 | 15 | 20 | 25 | 30 | 40 |
|---|---|---|---|---|---|---|
| Remaining volume | 650 | 550 | 450 | 350 | 250 | — |
| (mL) | | | | | | |
| Remainder (%) | 65 | 55 | 45 | 35 | 25 | — |
| Concentration in | 5.6 ± 0.3 | 6.5 ± 0.3 | 7.1 ± 0.4 | 7.8 ± 0.4 | 12.2 ± 0.6 | — |
| solid (g/L) | | | | | | |
| Concentration range | 0.6 ± 0.3 | 0.7 ± 0.3 | 0.8 ± 0.4 | 0.9 ± 0.4 | 1.4 ± 0.6 | — |
| in saponins (g/L) | 1.1 ± 0.3 | 1.3 ± 0.3 | 1.4 ± 0.4 | 1.5 ± 0.4 | 2.4 ± 0.6 | |
| Half-life (min) | 1.1 | 1.1 | 1.3 | 1 | 0.9 | — |

| | |
|---|---|
| Initial volume | 1000 mL |
| Maximum stability for | 7.1 ± 0.4 g/L |
| Equivalent concentration in | 0.8 ± 0.4 |
| saponins (g/L) | 1.4 ± 0.4 |
| Equivalent volume | 450 mL |
| Remainder amount expected | 45% |

The initial Natef recipe [28] instructs that the soapwort containing mixture should be boiled until about a fifth of the initial amount of water is left. In the present example, the mixture was only boiled until one-half to one-third (i.e. 40-45%) of the liquid remained. When processed in this manner, it was found that the filtrate formed the most stable foam, and moreover did not have the bitter taste that is present when the solution is too concentrated. If the solution is boiled until a quarter or a fifth of the initial liquid volume is left, the resulting meringue has an undesirable taste.

### Effect of Sugar

Sugar is added to stabilize the foam. However, adding syrup made of water and sugar as has been suggested in the Natef recipe [28], creating a sticky, creamy and much more liquid foam. When this mixture was baked, the resulting meringue took the form of a plain round flat cake, which is not the desired shape. In accordance with the present method, sugar is added alone and not in a syrup form, so that the addition of the same amount of sugar suggested in the Natef recipe, directly and by itself, and not within a syrup, unexpectedly resulted in the preparation of a meringue that is stable both at ambient temperature and at cooking temperature.

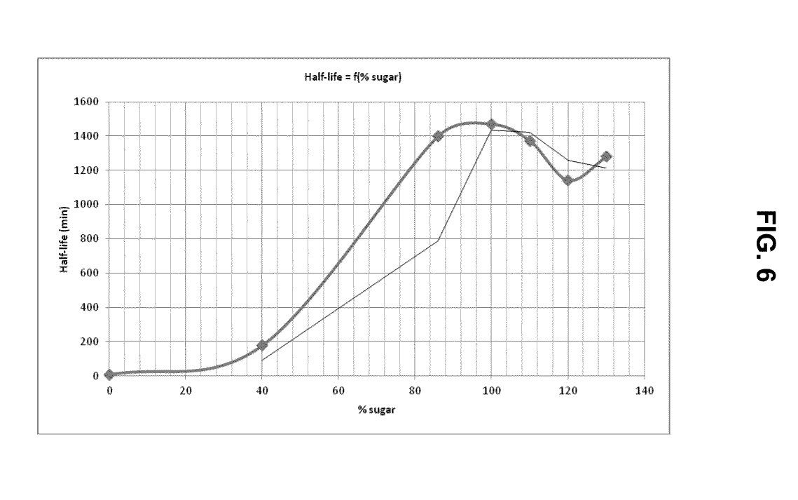

Thus, 30 grams of powdered soapwort root were placed in 3L of water (ratio 1:100) and soaked for one hour. The entire mixture was then boiled until 40% of the liquid remained, and was then filtered through a coffee filter (No. 4). Seven samples of 100 g of the filtrate were beaten separately for 5 minutes using an electric beater (Max Watts 300 KitchenAid, St. Joseph, Mich. USA) at setting 10. Thereafter, sugar in the following percentages; 0%, 40%, 86%, 100%, 110%, 120% and 130%; and corresponding to the following amounts; 0 g, 40 g, 86 g, 100 g, 110 g, 120 g and 130 g; was gradually added to individual respective samples. 86% sugar was taken as the reference amount and corresponds to the amount of sugar usually used in the Natef recipe [28] using a sugar syrup. The results are presented in FIG. 6, and demonstrate that maximum stability is achieved when sugar is present in the range of 85% to 115%.

Accordingly, adding sugar increases stability up to a certain point. Thus even if it delays the collapse of the foam, it also makes the foam more dense, so that when the foam is baked it does not retain the original extruded shape. This is important in the instance where a meringue product capable of being self supporting while being baked, is desired.

### Effect of pH

The effect of pH on the meringue was examined, and lemon juice was accordingly added in differing quantities. 10 grams of soapwort powder were soaked in 1L of water (ratio 1:100) for one hour. The entire mixture was then boiled for approximately 30 minutes and filtered through a coffee filter (No. 4). Three samples of 100g each of the filtrate were separately beaten for 5 minutes using an electric beater (Max Watts 300 KitchenAid, St. Joseph, Mich. USA) at setting 10.86 g sugar was added to the foam after the formation of soft peaks (ratio 100:86). Three samples were then prepared, to which were added 0 mL, 10 mL and 20 mL of lemon juice, respectively.

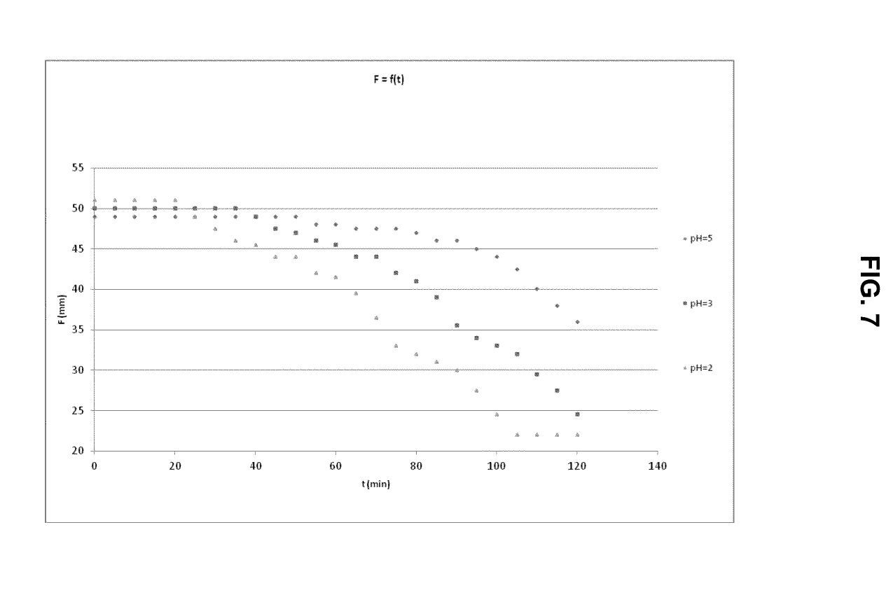

The first sample with no lemon juice added, had a pH=5; the second sample with 10 mL lemon juice added, had a pH=3; and the third sample with 20 mL of lemon juice added, had a pH=2. An initial comparison of foam height as a function of pH is presented in FIG. 7.

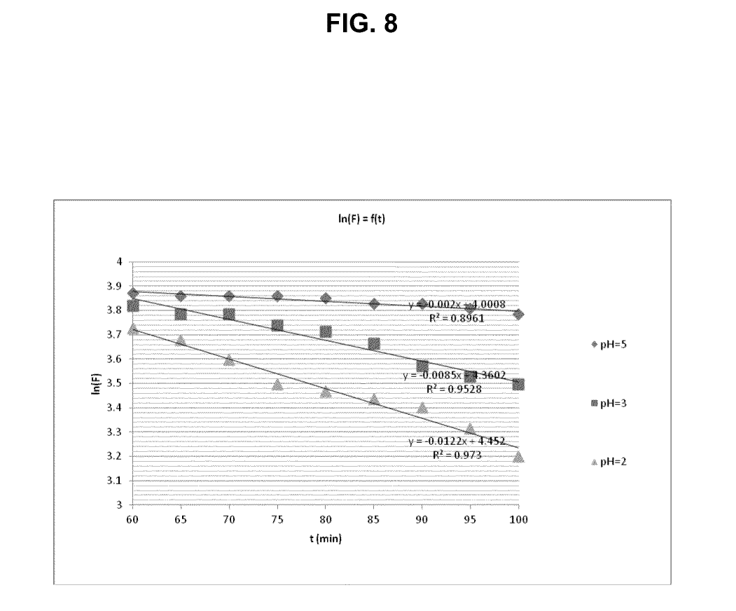

Referring to FIG. 7, there is little if any variation in the height of either the foam or the liquid during the first 30 minutes following preparation. Accordingly, a more detailed examination was made to measure and determine the half-life of the foam during a 40 minute period (between 60 and 100 minutes following foam formation) to compare the stability of each of the three samples. The results of this examination are presented in FIG. 8, and in Table 3, below.

TABLE 3

| pH | a | Half-life (min) |
|---|---|---|
| 5 | −0.002 | 346.5735903 |
| 3 | −0.0085 | 81.54672712 |
| 2 | −0.0122 | 56.81534267 |

Comparing the three stabilities, higher pH of the solution does not appear to have a significant influence on foam stability, however the foam is less stable at a very low pH. Separately, the level of the pH of the solution does not appear to affect its foam forming ability.

### Effect of Temperature

The stability determined under ambient conditions is distinct from the stability when the meringue is baked. Several combinations of baking regimes were tried before optimal temperature and baking time were found. The preferred conditions for the batch preparation as conducted, were 30 minutes at 200° F., followed by turning the oven off and permitting the product to cool for one hour.

To make the foam, 10 g of soapwort powder were placed in 1L of water (weight ratio 1:100) and soaked for one hour. The entire mixture was then boiled until between one half and one third of the liquid was driven off, and the resulting liquid was then filtered through a coffee filter (No. 4). The filtrate was beaten for 5 minutes using an electric beater (Max Watts 300 KitchenAid, St. Joseph, Mich. USA) at setting 10. Sugar was then added to the foam after the formation of soft peaks, with a mass of sugar equal to 86% of the mass of filtrate. The entire mass was beaten until stiff peaks formed.

The oven was preheated to 200° F., and the meringue was cooked under close supervision for a period of one hour. Excessive baking times give rise to the formation of pores, and the meringue additionally loses a smooth shape and glossy texture. Short baking times do not provide for a sufficiently dehydrated product with a uniform interior texture. A slow return to lower temperatures under dehydrating conditions is desirable; otherwise, the final meringue product may become rehydrated upon cooling.

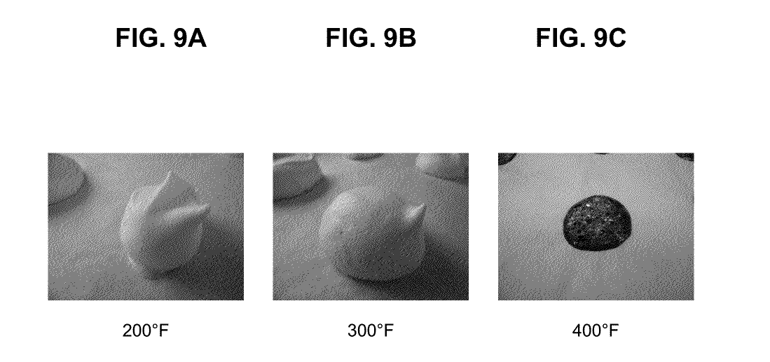

Variations in the heating temperature and regime at which the meringue product is heated can have an important effect on the properties of the final product. By way of example three ovens were heated to 200° F. (93° C.); 300° F. (149° C.) and 400° F. (204° C.), respectively. When the foam was cooked at 200° F. (93° C.), it maintained its bright white shape. At 300° F. (149° C.), the foam appeared drier and turned beige, while at 400° F. (204° C.), the meringue decomposed and turned dark brown. Thus, assuming all other conditions are maintained constant, increasing the heating temperature from 200° F. to 300° F. does not have a large impact on the final shape and taste of the meringue, however increasing the temperature from 300° F. to 400° F. radically changes the shape of the meringue, which indicates that the temperature range within which the meringue can be baked is rather narrow and critical from a cooking perspective, and consequently cooking the meringue is delicate. FIGS. 9A to 9C depict the appearance of meringue samples after cooking at each of the temperature levels indicated, e.g. 200° F., 300° F. and 400° F.

As stated earlier, the meringue product may be prepared to a final form other than that of a self sustaining foam article, to suit its end use in a prepared food. Accordingly, the meringue may be prepared either at a lower temperature, or may be heated for a shorter time period, to form a flowable marshmallow-like consistency and texture. Likewise, the means of heating may vary, and the product may be heated by microwave energy. In all instances, the exact heating regime should be carefully controlled to assure that the resulting product possesses the desired end characteristics.

This also appears to explain the color change from 200° F. to 300° F., and suggests that a caramelization reaction takes place; that is; a reaction of browning sugars exposed to heat which occurs around 300° F. in dishes with a 1 substantial quantity of sugar in relation to the amount of water. During this reaction both enediols and dicarbonyls are formed, which are responsible for the presence of caramel pigments and flavors. The caramelization reaction yields the dehydration product of the saccharide followed by the isomerization and polymerization. After 410° F., the sugar begins to break down to pure carbon which explains the dark color.

However, the temperature of the filtrate does not have an effect on its foaming ability, both cold and warm solutions make foam with a volume approximately ten times greater than the initial liquid volume.

It will be appreciated by those skilled in the art that the above example represents merely one way in which the advantages of the invention may be realized. There are likely to be numerous variations of the formulation and specific processing steps which will result in a product remaining within the spirit and scope of the invention.

### REFERENCES

[1] O. Güçlu-Üstundag, G. Mazza, 2007. Saponins: Properties, Applications and Processing. Critical Reviews in Food Science and Nutrition, 47:231-258
[2] Dictionary “Larousse”, Larousse (Paris)
[3] H. This, “Casseroles & Éprouvettes”, 2002, 146, Belin (Paris)
[4] H. McGee, “On Food and Cooking: The Science and Lore of the Kitchen”, 2004, 68, Scribner
[5] H. McGee, “On Food and Cooking: The Science and Lore of the Kitchen”, 2004, 68, Scribner
[6] Soap Nuts History, Wholesale Soap Nuts—Bulk Soap Nuts, English, 1, http://www.wholesalebulksoapnuts.com/soap-nuts-history/
Les noix de lavage, Mon Magasin Bio, French, 1, http://www.monmagasinbio.com/astuces_1.php
[7] D. Watts, “Elsevier's Dictionary of plant names and their origin”, 2000, Elsevier (Bath)
[8] Raffa, “Le Grand Ménage, recettes écologiques et économiques pour l'entretien de la maison”, 2006, 15, download on http://raffa.over-blog.com
Questions fréquentes: Les noix de lavage, Noix-de-lavage.be . . . La propreté au naturel., French, 1, http://www.noix-de-lavage.be/questions-noix-de-lavage.html
Saponaire, la plante, Journal d'une savonniére á la campagne, French, 1, http://www.saponaire.info/categorie-1146692.html
[9] Orwa et al., 2009, Sapindus mukorossi, Agroforestry Database 4.0
[10] J. D. Park, D. K. Rhee, Y. H. Lee, 2005, Biological activities and chemistry of saponins from Panax ginseng C. A. Meyer, Phytochemistry Reviews, 4, 159-175
[11] N. Kambouche, B. Merah, A. Derdour, S. Bellahouel, M. M. Benziane, C. Younos, M. Firkioui, S. Bedouhene, R. Soulimani, 2009, Etude de l'effet antidiabétique des saponines extraites d'Anabasis articulate (Forssk) Moq, plante utilisée traditionnellement en Algérie, Phytotherapie, 7, 197-201
[12] J. Raju, R. Mehta, 2009, Cancer Chemopreventive and Therapeutic Effects of Diosgenin, a Food Saponin, Nutrition and Cancer, 61(1), 27-35
S. Shibata, 2001, Chemistry and Cancer Preventing Activities of Ginseng Saponins and Some Related Triterpenoid Compounds, J Korean Med Sci, 16(Suppl): S28-37
A. V. Rao, M.-K. Sung, 1995, Saponins as Anticarcinogens, The Journal of Nutrition, 0022-3166/95
[13] S. G. Sparg, M. E. Light, J. van Staden, 2004, Biological activities and distribution of plant saponins, Journal of Ethnopharmacology, 94, 219-243
[14] G. S. Katselis, A. Estrada, D. K. J. Gorecki, B. Barl, 2007, Adjuvant activities of saponins from the root of Polygala senega L., Can. J. Physiol. Pharmacol. 85, 1184-1194
P. R. Cheeke, 2000, Actual and potential applications of Yucca schidigera and Quillaja saponaria saponins in human and animal nutrition, J Anim Sci., 77:1-10
[15] G. S. Sidhu, D. G. Oakenfull, 1986, A mechanism for the hypocholesterolaemic activity of saponins, British Journal of Nutrition, 55, 643-649
J. Laguna, A. Gomez-Puyou, A. Pena, J. Guzman-Garcia, 1962, Effect of diosgenin on cholesterol metabolism, Journal of Atherosclerosis Research, 2, 459-470
S. M. Potter, R. Jimenez-Flores, J. Pollack, T. A. Lone, M. D. Berber-Jimened, 1993, Protein-Saponin Interaction and Its Influence on Blood Lipids, J. Agric. Food Chem., 41, 1287-1291
[16] D. Oakenfull, 1981, Saponins in food—a review, Food Chemistry, 6, 19-40
S. G. Sparg, M. E. Light, J. van Staden, 2004, Biological activities and distribution of plant saponins, Journal of Ethnopharmacology, 94, 219-243
A. J. George, 1965, Legal Status and Toxicity of Saponins, Fd Cosmet. ToxicoL Vol. 3, 85-91
[17] D. Oakenfull, 1981, Saponins in food—a review, Food Chemistry, 6, 19-40
A. J. George, 1965, Legal Status and Toxicity of Saponins, Fd Cosmet. ToxicoL Vol. 3, 85-91
[18] P. R. Cheeke, 2000, Actual and potential applications of Yucca schidigera and Quillaja saponaria saponins in human and animal nutrition, J Anim Sci., 77:1-10
Ö. Güçlu-Üstündag, G. Mazza, 2007, Saponins: Properties, Applications and Processing, Food Science and Nutrition, 47, 231-258
Applications & Sample Formulations, Desert King International, English, 1, http://www.desertking.com/index.cfm/category/11/applications-sample-formulations.cfm, 2011
D. J. Mabberley, “The Plant-Book”, 2nd Edition, 1998, Cambridge University Press (Cambridge)
[19] P. R. Cheeke, 2000, Actual and potential applications of Yucca schidigera and Quillaja saponaria saponins in human and animal nutrition, J Anim Sci. 77:1-10.
Food & Beverages—Yucca and Quillaja Extracts Natural Foaming and Emulsifying Agents for the Food & Beverage Industry, Desert King International, English, 1, http://www.desertking.com/index.cfm/category/3/food-beverages.cfm, 2011
[20] Z. Jia, K. Koike, and T. Nikaido, 1998, Major Triterpenoid Saponins from Saponaria officinalis, J. Nat. Prod, 61, 1368-1373
[21] D. Watts, “Elsevier's Dictionary of plant names and their origin”, 2000, Elsevier (Bath)
[22] C. Roden, “A Book of Middle Eastern Food”, 1970, Penguin Books (Harmondsworth)
[23] Encyclopedia on Contemporary Medicinal Plants—Saponaria officinalis (Soapwort), Hong Kong Jockey Club Institute of Chinese Medicine, English, 1, http://www.hkjcicm.org/cm_database/plants/detail_e.aspx?herb_id=231, 2011
[24] J. Wu, L. Lin, F.-T. Chau, 2001, Ultrasound-assisted extraction of ginseng saponins from roots and cultured ginseng cells, Ultrasonics Sonochemistry 8, 347-352
[25] C. E. Wallin, M. B. DiPietro, R. W. Schwarz, C. W. Bamforth, 2010, A comparison of three methods for the assessment of foam stability of beer, J. Inst. Brew., 116(1), 78-80
[26] A. E. Ceyhun Sezgin, N. Artik, 2010, Determination of Saponin Content in Turkish Tahini Halvah by using HPLC, Advance Journal of Food Science and Technology, 2(2): 109-115
[27] G. S. Katselis, A. Estrada, D. K. J. Gorecki, B. Barl, 2007, Adjuvant activities of saponins from the root of Polygala senega L., Can. J. Physiol. Pharmacol. 85, 1184-1194
[28] L. Heng, J.-P. Vincken, K. Hoppe, G. A. van Koningsveld, K. Decroos, H. Gruppen, M. A. J. S. van Boekel, A. G. J. Voragen, 2006, Stability of pea DDMP saponin and the mechanism of its decomposition, Food Chemistry, 99, 326-334
[29] J.-H. Kwon, J. M. R. Belanger, J. R. J. Pare, V. A. Yaylayan, 2003, Application of the microwave-assisted process to the fast extraction of ginseng saponins, Food Research International, 36, 491-498
T. Lalitha, R. Seshadri, L. V. Venkataraman, 1987, Isolation and Properties of Saponins from Madhuca butyracea Seeds, J. Agric. Food Chem., 35, 744-748
S. Shany, Y. Birk, B. Gestetner, A. Bond, 1970, Preparation, characterisation and some properties of saponins from lucerne tops and roots, J. Sci. Fd Agric., Vol. 21, March
J. J. VIREY, “Traité de pharmacie: théorique et pratique”, 1811, 32, Rémont (Paris)
E. SOUBEIRAN, “Nouveau traité de pharmacie théorique et pratique”, 1836, 182, Crochard (Paris)
[28] Karabeej of Aleppo, Discover Lebanon, English, 1, http://www.discoverlebanon.com/en/recipes/karabeej_aleppo.php

1. A meringue product that is free from any egg or egg byproducts, and is formed from a meringue mixture consisting essentially of a saponin-rich component, a sugar component, and water.

2. (canceled)

3. The meringue product of claim 1, wherein said saponin is derived from a plant selected from Yucca schidigera, Quillaja saponaria, and Saponaria officinalis.

4. The meringue product of claim 3, wherein said saponin is derived from Saponaria officinalis (soapwort).

5. The meringue product of claim 1, wherein said sugar component is selected from granulated sugar and powdered sugar, and is added to the mixture in the selected form.

6. (canceled)

7. The meringue product of claim 1, further including bulking agents, flavors, and foaming agents.

8. The meringue product of claim 5, wherein the bulking agents include wheat starch, com starch, rice starch and tapioca starch; and the flavors include vanilla, chocolate, mocha, coffee, fruit flavors and nut flavors.

9. The meringue product of claim 1, wherein the sugar component is a sugar substitute, and is selected from maltodextrose, dextrose, sorbitol, xylitol and maltitol; and synthetic sweeteners selected from saccharin, stevioside, aspartame, sucralose, cyclodextrin, and mixtures thereof.

10. A method for the preparation of a meringue product comprising:
a. preparing a mixture of a saponin-rich component, a sugar component and water; and
b. heating the mixture of step a. at a temperature sufficient to cause said mixture to form a self-supporting meringue product.

11. The method of claim 10, wherein said mixture is maintained at a pH of about 5.

12. The method of claim 10, wherein said saponin-rich component is prepared from a plant selected from Yucca schidigera, Quillaja saponaria, and Saponaria officinalis.

13. The method of claim 12, wherein said saponin-rich component is derived from Saponaria officinalis (soapwort).

14. The method of claim 10, wherein said saponin-rich component is prepared by liquid extraction from plant material.

15. The method of claim 14, wherein said plant material is selected from whole roots and powdered plant material.

16. The method of claim 14, wherein said extraction is conducted in water.

17. The method of claim 10, wherein said sugar component is selected from granulated sugar and powdered sugar, and is added to the mixture in the selected form.

18. (canceled)

19. The method of claim 10, wherein said sugar component is present in an amount ranging from about 85% to about 115% by weight.

20. The method of claim 14, wherein following the liquid extraction of said saponin component, the resultant extract is heated or treated to reduce the volume thereof by about 50% to about 80%.

21. The method of claim 20, wherein, after the volume of the extract is reduced, the resulting liquid is clarified by filtration or centrifugation and thereafter agitated as by beating.

22. The method of claim 21, wherein after the mixture is agitated, the sugar component is added and the resulting mixture is further agitated.

23. The method of claim 10, wherein said mixture is heated at a temperature ranging from about 150° F. to about 300° F.

24. The method of claim 10, wherein said mixture is heated a temperature ranging from about 150° F. to about 200° F.

25. The method of claim 10, wherein said mixture is heated for about 1 hour at a temperature of about 200° F.

26. The method of claim 10, wherein said mixture is heated by microwave heating.

27. The meringue product of claim 1, wherein said meringue product is selected from a prepared, baked meringue product and a dried and granulated meringue product.
